(19) United States
(12) Patent Application Publication
(10) Pub. No.: US 2025/0355378 A1
(43) Pub. Date: Nov. 20, 2025

(54) TONER AND METHOD OF MANUFACTURING TONER

(71) Applicant: KYOCERA Document Solutions Inc., Osaka (JP)

(72) Inventor: Takatoshi NOZAKI, Osaka (JP)

(73) Assignee: KYOCERA Document Solutions Inc., Osaka (JP)

(21) Appl. No.: 19/195,915

(22) Filed: May 1, 2025

(30) Foreign Application Priority Data
May 15, 2024 (JP) 2024-079121

(51) Int. Cl. G03G 9/087; G03G 9/08; G03G 9/093; G03G 9/097

(52) U.S. Cl. CPC G03G 9/08711; G03G 9/0815; G03G 9/09314; G03G 9/09364; G03G 9/09775

(57) ABSTRACT

Toner contains toner particles. The toner particles contain a binder resin and a positively chargeable charge control agent. The most abundant resin in the binder resin in terms of mass is styrene-acrylic resin with an acid number of 7.0 mgKOH/g or more. The charge attenuation constant of the toner particles is −0.0200 or more in an environment of a temperature of 32.5° C. and a relative humidity of 80%.

### INCORPORATION BY REFERENCE

This application is based on and claims the benefit of priority from Japanese Patent Application No. 2024-079121 filed on May 15, 2024, the contents of which are hereby incorporated by reference.

### BACKGROUND

The present disclosure relates to toner, and also relates to a method of manufacturing toner.

In image formation employing an electrophotographic method, for example, toner containing toner particles is used.

### SUMMARY

According to one aspect of the present disclosure, toner contains toner particles. The toner particles contain a binder resin and a positively chargeable charge control agent. The most abundant resin in the binder resin in terms of mass is styrene-acrylic resin with an acid number of 7.0 mgKOH/g or more. The charge attenuation constant of the toner particles is −0.0200 or more in an environment of a temperature of 32.5° C. and a relative humidity of 80%.

According to another aspect of the present disclosure, a method of manufacturing the above toner involves a treatment process of treating untreated toner particles with alcohol to obtain the toner particles.

This and other objects of the present disclosure, and the specific benefits obtained according to the present disclosure, will become apparent from the description of embodiments which follows.

### BRIEF DESCRIPTION OF THE DRAWINGS

FIG. 1 is a diagram showing one example of toner particles contained in toner according to the present disclosure.

FIGS. 2A and 2B are diagrams illustrating one example of a treatment process involved in a method of manufacturing toner according to the present disclosure.

### DETAILED DESCRIPTION

An embodiment of the present disclosure will be described below. First, problems with known technologies will be discussed.

For example, in known toner, toner particles have toner base particles. The toner base particles contain a binder resin, a magnetic powder, and a charge control agent. The binder resin contains a block polymer, which has a polyester part and a vinyl polymer part. The charge control agent contains a styrene acrylic resin having a quaternary ammonium group. The content proportion of charge control agent in toner base particles is 1.5 mass % or more but 12.0 mass % or less.

Inconveniently, from the viewpoint of forming high-quality images in a high-temperature, high-humidity environment, the known toner mentioned above leaves room for improvement.

In view of the above drawback, an object of the present disclosure is to provide toner that can form high-quality images in a high-temperature, high-humidity environment and a method of manufacturing such toner.

An embodiment of the present disclosure will now be described. First, some of the terms used in the present specification will be defined. Toner is an aggregate (e.g., powdery substance) of toner particles. An external additive is an aggregate (e.g., powdery substance) of external additive particles. Unless otherwise defined, a result of evaluation (i.e., a value related to a shape, property, or the like) with respect to a powdery substance (specifically, a powdery substance of toner particles, a powdery substance of external additive particles, and the like) is given as a number average of values obtained respectively for an appropriate number of particles selected from the powdery substance. Unless otherwise defined, a volume median diameter (the value D₅₀ of a cumulative 50% in a volume-based particle size distribution) is a median diameter measured using a laser diffraction/scattering particle size distribution analyzer (“LA-950” manufactured by Horiba Ltd.). Unless otherwise defined, a glass transition point (Tg) is a value measured using a differential scanning calorimeter (“DSC-6220” manufactured by Seiko Instruments Inc.) in conformity with JIS (Japanese Industrial Standards) K7121-2012. In an endothermic curve (vertical axis: heat current (DSC signal), horizontal axis: temperature) measured using the differential scanning calorimeter, the temperature at the inflexion point ascribable to glass transition (specifically, the temperature at the intersection between an extrapolation line on a base line and an extrapolation line on a falling line) corresponds to Tg (glass transition point). Unless otherwise defined, an acid number is a value measured in conformity with JIS (Japanese Industrial Standards) K0070-1992. Unless otherwise defined, a relative humidity is a value measured in conformity with JIS (Japanese Industrial Standards) Z8806:2001. Unless otherwise defined, a charge amount (in μC/g) is a value measured using a compact toner draw-off charge measurement system (“Model 210HS” manufactured by Trek Inc.) in an environment of a temperature of 25° C. and a relative humidity of 50% RH. The degree of hydrophobicity can be represented by the contact angle of a water drop. A larger contact angle of a water drop denotes a higher degree of hydrophobicity. The term “(meth)acrylic” is occasionally used to refer to “acrylic” and “methacrylic” collectively. The term “(meth)acrylonitrile is occasionally used to refer to “acrylonitrile” and “methacrylonitrile” collectively. Unless otherwise defined, the “chief component” of a material is the component most abundant in the material in terms of mass. Any one of the components mentioned in the present specification can be used singly or a plurality of them in combination. This is how some of the terms used in the present specification should be understood.

### Toner

Toner according to an embodiment of the present disclosure will be described. The toner of the embodiment contains toner particles. The toner particles contain a binder resin and a positively-chargeable charge control agent. The resin most abundant in the binder resin in terms of mass is styrene-acrylic resin with an acid number of 7.0 mgKOH/g or more. The charge attenuation constant of the toner particles is −0.0200 or more in an environment of a temperature of 32.5° C. and a relative humidity of 80%.

In the following description, the “resin most abundant in the binder resin in terms of mass” is occasionally referred to simply as the “most abundant resin.” An “environment of a temperature of 32.5° C. and a relative humidity of 80% ” is occasionally referred to simply as the “predetermined HH environment.”

With the above design, the toner of the embodiment can form high-quality images in a high-temperature, high-humidity environment (offering, in particular, high-quality images with no breaks in thin lines and no toner scattering). The reasons are inferred to be as follows.

For sufficient charging of toner in a high-temperature, high-humidity environment, it is effective to increase the acid number of the binder resin so that a large amount of positively chargeable charge control agent is present in the toner particles. Accordingly, in the embodiment, chosen as the most abundant resin in the binder resin is styrene-acrylic resin with an acid number of 7.0 mgKOH/g or more. Styrene-acrylic resin with an acid number of 7.0 mgKOH/g or more has a large number of carboxy groups and thus, during the manufacture of toner, electrostatically attracts a large amount of positively chargeable charge control agent. This permits the toner particles to contain a large amount of positively chargeable charge control agent, and allows the toner to be charged sufficiently in an high-temperature, high-humidity environment.

However, an increased acid number of the binder resin tends to result in quick attenuation of the charge on the toner particles in a high-temperature, high-humidity environment. To cope with that, in the embodiment, the charge attenuation constant of the toner particles is set at −0.0200 or more in the predetermined HH environment. Giving the toner particles a charge attenuation constant of −0.0200 or more in a high-temperature, high-humidity environment (e.g., the predetermined HH environment) makes the charge on them less prone to attenuate and the charge on the toner is less prone to drop with time. This makes it possible to form high-quality images with no breaks in thin lines and no toner scattering in a high-temperature, high-humidity environment.

These are the reasons why the toner of the embodiment can form high-quality images (in particular, high-quality images with no breaks in thin lines and no toner scattering) in a high-temperature, high-humidity environment.

### Toner Particles

The toner particles contain a binder resin and a positively chargeable charge control agent. The toner particles can further contain, as necessary, an internal additive (e.g., at least one of a colorant, a release agent, and any component other than those). From the viewpoint of forming satisfactory images, the volume median diameter (D₅₀) of the toner particles is preferably 4 μm or more but 9 μm or less.

As already mentioned, the charge attenuation constant of the toner particles is −0.0200 or more in the predetermined HH environment. To form high-quality images with no breaks in thin lines and no toner scattering in a high-temperature, high-humidity environment, the charge attenuation constant of the toner particles is preferably −0.0190 or more, and more preferably −0.0180 or more. To form images with the toner sufficiently charged in a high-temperature, high-humidity environment, the charge attenuation constant of the toner particles is preferably −0.0100 or less. The charge attenuation constant of the toner particles can be controlled, for example, by treating untreated toner particles with alcohol in a treatment process, which will be described later, and thereby reducing the acid number near the surface of the toner particles. In a case where the toner particles have an external additive as will be described later, the “charge attenuation constant of the toner particles” means the charge attenuation constant of toner base particles (toner base particles as they are before the addition of the external additive).

To form images with the toner sufficiently charged in a high-temperature, high-humidity environment, the charge amount of the toner particles in the predetermined HH environment is preferably +10.0 μC/g or more, more preferably +10.0 μC/g or more but +30.0 μC/g or less, and still more preferably +15.0 μC/g or more but +20.0 μC/g or less. In a case where the toner particles have an external additive as will be described later, the “charge amount of the toner particles” means the charge amount of toner base particles (toner base particles as they are before the addition of the external additive).

For sufficient charging of the toner in a high-temperature, high-humidity environment, it is effective to increase the acid number of the binder resin so that a large amount of positively chargeable charge control agent is present in the toner particles. The charging of the toner particles is particularly affected by the amount of positively chargeable charge control agent contained in a surface region of the toner particles. For example, the larger the amount of positively chargeable charge control agent contained in a surface region of the toner particles compared with the amount of positively chargeable charge control agent contained in an inner region of the toner particles, the more easily the toner particles are charged.

On the other hand, an increased acid number of the binder resin tends to result in quick attenuation of the charge on the toner particles in a high-temperature, high-humidity environment. The attenuation of the electric charge on the toner particles is affected particularly by the acid number in a surface region of the toner particles. For example, the lower the acid number in a surface region of the toner particles compared with the acid number in an inner region of the toner particles, the electric charge on the toner particles is less prone to attenuate.

The following description assumes that the toner particles contained in the toner of the embodiment are capsule toner particles.

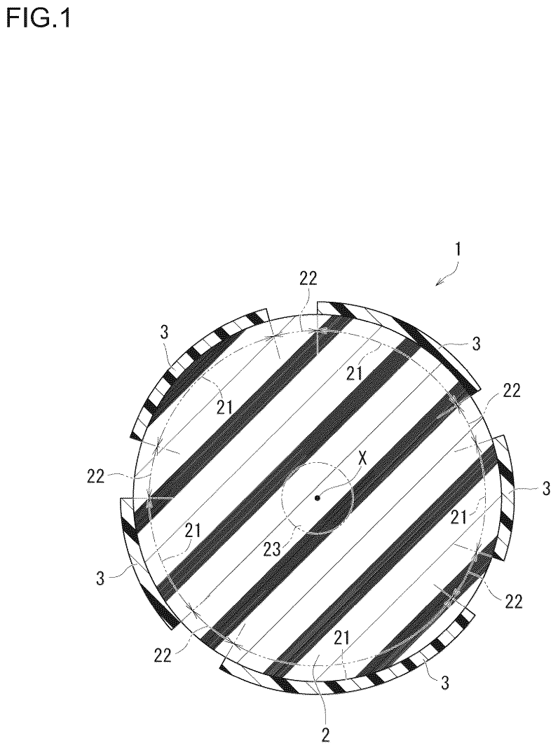

With reference to FIG. 1, the structure of the toner particles contained in the toner of the embodiment will be described. FIG. 1 shows a toner particle 1 as one example of the toner particles contained in the toner of the embodiment. The toner particle 1 has a toner core 2 and a shell layer 3 coating the toner core 2. The toner particle 1 is a capsule toner particle that has a shell layer 3. In a case where the toner particle 1 is a capsule toner particle, the toner core 2 contains a binder resin and the shell layer 3 contains a positively chargeable charge control agent. The surface of the toner core 2 has a coated region 21 that is coated by the shell layer 3 and an exposed region 22 that is not coated by the shell layer 3. The exposed region 22 is, for example, discontinuously distributed over the surface of the toner core 2. The toner core 2 has an inner region 23. The inner region 23 is a spherical region with its center at the center X of the toner core 2. The radius of the inner region 23 is, for example, one-fifth of the radius of the toner core 2.

Thus far is a description, with reference to FIG. 1, of the structure of the toner particles contained in the toner of the embodiment. It should however be noted that the toner particle 1 described above is not meant to limit the toner particles contained in the toner of the embodiment, which thus can be modified as follows. For example, while the toner particle 1 shown in FIG. 1 does not contain an external additive, this is not meant as any limitation. The toner particles can have an external additive. In a case where the toner particles have an external additive, the toner particle 1 shown in FIG. 1 corresponds to a toner base particle, with the external additive adhering to the surface of the toner base particle. For another example, while the toner particle 1 shown in FIG. 1 has a shell layer 3, this is not meant as any limitation. The toner particles can be non-capsule toner particles that have no shell layer. For example, while in the toner particle 1 shown in FIG. 1 the shell layer 3 coats part of the toner core 2 (which thus has a coated region 21 and a exposed region 22), this is not meant as any limitation. The shell layer of the toner particles can coat the entire toner core.

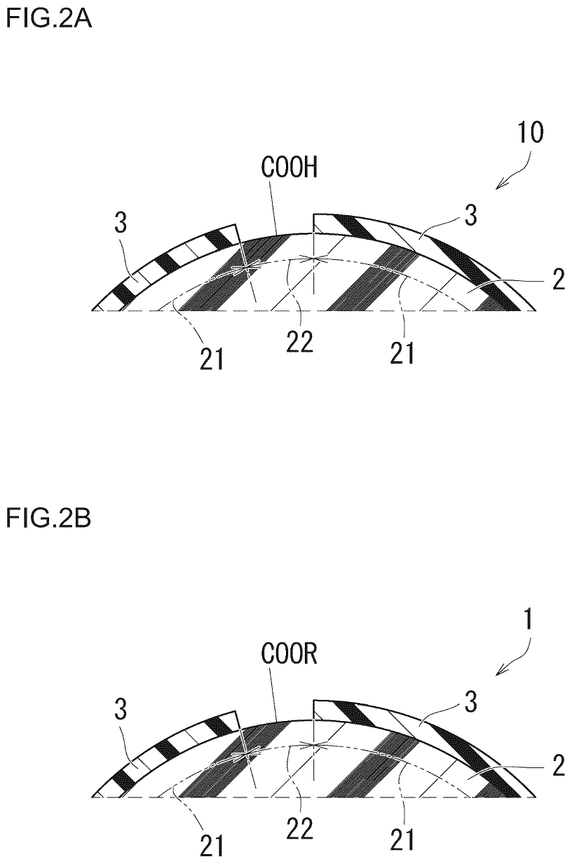

Next, for clearer understanding, with reference to FIGS. 2A and 2B, an outline of the treatment process performed during the manufacture of the toner of the embodiment will be described. FIGS. 2A and 2B are diagrams illustrating the treatment process involved in a method of manufacturing the toner of the embodiment. As shown in FIG. 2A, an untreated toner particle 10 before the treatment process has a toner core 2 and a shell layer 3 coating the toner core 2. The surface of the toner core 2 of the untreated toner particle 10 has a coated region 21 that is coated by the shell layer 3 and an exposed region 22 that is not coated by the shell layer 3. The toner core 2 has a carboxy group (—COOH group) that belongs to the styrene-acrylic resin with an acid number of 7.0 mgKOH/g or more contained in the binder resin. In the treatment process, the untreated toner particle 10 is treated with alcohol (R—OH, where R is an alkyl group). This exposes the exposed region 22 of the toner core 2 to the alcohol. Thus, in the exposed region 22 of the toner core 2, the carboxy group belonging to the styrene-acrylic resin contained in the toner core 2 engages in an esterification reaction with the alcohol to form an alkoxycarbonyl group (—COOR group, where R is an alkyl group). Thus the toner core 2 comes to have an alkoxycarbonyl group in the exposed region 22. In this way, a treated toner particle 1 as shown in FIG. 2b is obtained. Thus far is a description, with reference to FIGS. 2A and 2B, of an outline of the treatment process. The treatment process will be described in detail later.

The toner core contains, as the most abundant resin in the binder resin, styrene-acrylic resin with an acid number of 7.0 mgKOH/g or more. Owing to this, in a shell formation process, which will be described later, the toner core, which contains the binder resin with a high acid number, attracts a large amount of positively chargeable charge control agent as the shell material. This permits a large amount of positively chargeable charge control agent to be present in a surface region of the toner particles so that the toner can be sufficiently charged in a high-temperature, high-humidity environment.

As already mentioned, the toner core contains a binder resin and the shell layer contains a positively chargeable charge control agent. Owing to this arrangement of materials, the amount of positively chargeable charge control agent contained in the surface region of the toner particles is larger than the amount of positively chargeable charge control agent contained in the inner region of the toner particles. The toner particles are then easier to charge and the toner can be sufficiently charged in an high-temperature, high-humidity environment. For the amount of positively chargeable charge control agent contained in the surface region of the toner particles to be larger than the amount of positively chargeable charge control agent contained in the inner region of the toner particles, preferably, the toner core contains no positively chargeable charge control agent.

In the treatment process, the exposed region on the surface of the toner core is exposed to alcohol. Thus the carboxy group in the exposed region is replaced with an alkoxycarbonyl group, so that the acid number in the exposed region on the surface of the toner core in the toner particles after the treatment process is lower than the acid number in the exposed region on the surface of the toner core in the untreated toner particles before the treatment process. On the other hand, in the treatment process, the inner region of the toner core is not exposed to alcohol. Thus the carboxy group in the inner region of the toner core is not replaced with an alkoxycarbonyl group, so that the acid number in the inner region of the toner core in the toner particles after the treatment process is similar to the acid number in the inner region of the toner core in the untreated toner particles before the treatment process. Accordingly, performing the treatment process results in the acid number in the exposed region on the surface of the toner core being lower than the acid number in the inner region of the toner core. Thus the acid number in the surface region of the toner particles is lower than the acid number in the inner region of the toner particles. As a result, the electric charge on the toner particles is less prone to attenuate and it is possible to form high-quality images with no breaks in thin lines and no toner scattering in a high-temperature, high-humidity environment.

### Toner Core

The toner core contains a binder resin. The toner core can further contain, as necessary, an internal additive (e.g., at least one of a colorant, a release agent, and any component other than those). The toner core can contain a positively chargeable charge control agent but, as mentioned above, preferably it contains no positively chargeable charge control agent. In a case where the toner core contains a positively chargeable charge control agent, one similar to the positively chargeable charge control agent contained in the shell layer can be used.

### Binder Resin

The content proportion of the binder resin is preferably 60 mass % or more but 95 mass % or less, and more preferably 75 mass % or more but 90 mass % or less.

As already mentioned, the most abundant resin in the binder resin is styrene-acrylic resin with an acid number of 7.0 mgKOH/g or more. In the shell formation process, to permit the toner core to attract a large amount of positively chargeable charge control agent as the shell material, the content proportion of styrene-acrylic resin with an acid number of 7.0 mgKOH/g or more relative to the mass of the binder resin is preferably 50 mass % or more but 100 mass % or less, more preferably 60 mass % or more but 95 mass % or less, still more preferably 65 mass % or more but 90 mass % or less, and particularly preferably 70 mass % or more but 80 mass % or less.

In the shell formation process, to permit the toner core attract a large amount of positively chargeable charge control agent as the shell material, the content proportion of styrene-acrylic resin with an acid number of 7.0 mgKOH/g or more relative to the mass of the toner core is preferably 50 mass % or more but 95 mass % or less, more preferably 55 mass % or more but 80 mass % or less, and still more preferably 60 mass % or more but 70 mass % or less.

As already mentioned, the acid number of the styrene-acrylic resin is 7.0 mgKOH/g or more. To sufficiently charge the toner in a high-temperature, high-humidity environment, the acid number of the styrene-acrylic resin is preferably 7.0 mgKOH/g or more but 20.0 mgKOH/g or less, more preferably 8.0 mgKOH/g or more but 18.0 mgKOH/g or less, and still more preferably 10.0 mgKOH/g or more but 15.0 mgKOH/g or less.

The glass transition point of the styrene-acrylic resin is preferably 40° C. or more but 65° C. or less, and more preferably 45° C. or more but 60° C. or less.

Styrene-acrylic resin is a polymer of at least one type of styrene-based monomer and at least one type of acrylic acid-based monomer.

A styrene-based monomer is styrene or a derivative of it. Examples of styrene-based monomers include styrene, alkylstyrenes (specifically, α-methyl styrene, p-ethyl styrene, 4-tert-butyl styrene, and the like), and styrene halides (specifically, α-chlorostyrene, o-chlorostyrene, m-chlorostyrene, p-chlorostyrene, and the like).

An acrylic acid-based monomer is (meth)acrylic acid or a derivative of it. Examples of acrylic acid-based monomer include (meth)acrylic acid, (meth acrylamide, (meth)acrylonitryile, alkyl esters of (meth)acrylic acid, and hydroxyalkyl esters of (meth)acrylic acid. Examples of alkyl esters of (meth)acrylic acid include methyl (meth)acryliate, ethyl (meth)acryliate, propyl (meth)acryliate (specifically, n-propyl (meth)acryliate, iso-propyl (meth)acryliate, and the like), butyl (meth)acryliate (specifically, n-butyl (meth)acryliate, iso-butyl (meth)acryliate, and the like), and 2-ethylhexyl (meth)acryliate. Examples of hydroxyalkyl esters of (meth)acrylic acid include 2-hydroxyethyl (meth)acryliate, 3-hydroxypropyl (meth)acryliate, 2-hydroxypropyl (meth)acryliate, and 4-hydroxybutyl (meth)acryliate.

The binder resin can only contain styrene-acrylic resin with an acid number of 7.0 mgKOH/g or more. However, the binder resin can contain, in addition to styrene-acrylic resin with an acid number of 7.0 mgKOH/g or more, any other resin (in the following description occasionally referred to as the “other binder resin.”

From the viewpoint of providing toner with good low-temperature fixing properties, the other binder resin is preferably a thermoplastic resin. Thermoplastic resins includes, for example, styrene resin, acrylic resin, olefin resin (e.g., polyethylene resin and polypropylene resin), vinyl resin (e.g., vinyl chloride resin, polyvinyl alcohol, vinyl ether resin, and N-vinyl resin), polyester resin, polyamide rein, and urethane resin. Also usable as the other binder resin are copolymers of those resins, that is, copolymers resulting from introducing into any of those resins any recurring unit (e.g., styrene-acrylic resin with an acid number less than 7.0 mgKOH/g and a styrene butadiene resin). The other binder resin is preferably styrene-acrylic resin with an acid number less than 7.0 mgKOH/g or polyester resin.

The acid number of the other binder resin is preferably less than 7.0 mgKOH/g, and more preferably 0.1 mgKOH/g or more but 5.0 mgKOH/g or less. The glass transition point of the other binder resin is preferably 40° C. or more but 65° C. or less, and more preferably 45° C. or more but 60° C. or less.

The content proportion of the other binder resin relative to the mass of the binder resin is preferably more than 0 mass % but 50 mass % or less, more preferably 5 mass % or more but 40 mass % or less, still more preferably 10 mass % or more but 35 mass % or less, and particularly preferably 20 mass % or more but 30 mass % or less.

The content proportion of the other binder resin relative to the mass of the toner core is preferably 5 mass % or more but 49 mass % or less, more preferably 10 mass % or more but 40 mass % or less, and still more preferably 20 mass % or more but 30 mass % or less.

### Colorant

As the colorant, any known pigment or dye can be used that suits the color of the toner. From the viewpoint of forming high-quality images with the toner, the content proportion of the colorant relative to 100 mass parts of the binder resin is preferably 1 mass part or more but 20 mass parts or less.

The colorant can be a black or color colorant. Examples of color colorants include yellow, magenta, and cyan colorants.

Examples of black colorants include, for example, carbon black. Black colorants can be those prepared to be black from yellow, magenta, and cyan colorants.

Usable as a yellow colorant is, for example, one or more compounds selected from the group consisting of condensed azo compounds, isoindolinone compounds, anthraquinone compounds, azo metal complexes, methine compounds, and aryl amide compounds. Examples of yellow colorants include, for example, C.I. Pigment Yellows (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, and 194), Naphthol Yellow S, Hansa Yellow G, and C.I. Vat Yellow.

Usable as a magenta colorant is, for example, one or more compounds selected from the group consisting of condensed azo compounds, diketo-pyrrolo-pyrrole compounds, anthraquinone compounds, quinacridone compounds, organic dye lake compounds, naphthol compounds, benzimidazolone compounds, thioindigo compounds, and perylene compounds. Examples of magenta colorants include, for example, C.I. Pigment Reds (2, 3, 5, 6, 7, 19, 23, 48:2, 48:3, 48:4, 57:1, 81:1, 122, 144, 146, 150, 166, 169, 177, 184, 185, 202, 206, 220, 221, and 254).

Usable as a cyan colorant is, for example, one or more compounds selected from the group consisting of copper phthalocyanine compounds, anthraquinone compounds, and organic dye lake compounds. Examples of cyan colorants include, for example, C.I. Pigment Blue (1, 7, 15, 15:1, 15:2, 15:3, 15:4, 60, 62, and 66), Phthalocyanine Blue, C.I. Vat Blue, and C.I. Acid Blue.

### Release Agent

A release agent is used to give the toner resistance to offsetting. From the viewpoint of giving the toner sufficient resistance to offsetting, the content proportion of the release agent relative to 100 mass parts of the binder resin is preferably 1 mass part or more but 20 mass parts or less.

Examples of release agents include, for example, aliphatic hydrocarbon-based wax, oxides of aliphatic hydrocarbon-based waxes, plant-based waxes, animal-based waxes, mineral-based waxes, ester waxes containing as a chief component a fatty acid ester, and waxes in which the whole or part of a fatty acid ester is deoxidized. Examples of aliphatic hydrocarbon-based waxes include, for example, low-molecular-weight polyethylene, low-molecular-weight polypropylene, polyolefin copolymers, polyolefin waxes, microcrystalline waxes, paraffin waxes, and Fischer-Tropsch waxes. Examples of oxides of aliphatic hydrocarbon-based waxes include, for example, polyethylene oxide waxes and block copolymers of polyethylene oxide waxes. Examples of plant-based waxes include, for example, candelilla wax, carnauba wax, tree wax, jojoba wax, and rice wax. Examples of animal-based waxes include, for example, beeswax, lanolin, and whale wax. Examples of mineral-based waxes include, for example, ozokerite, ceresin, and petrolatum. Examples of ester waxes containing as a chief component a fatty acid ester include, for example, montanic acid ester wax and caster wax. Examples of waxes in which the whole or part of a fatty acid ester is deoxidized include, for example, deoxidized carnauba wax. A preferred release agent is an ester wax.

### Other Components

Examples of other components that the toner core can contain include, for example, a charge control agent, a magnetic powder, a compatibilizing agent, and any known additive. However, as mentioned above, preferably, the toner core contains no contain charge control agent (e.g., positively chargeable charge control agent). The toner core need not contain a magnetic powder.

### Shell Layer

The shell layer contains, for example, a positively chargeable charge control agent and a rein. In the following description, the resin contained in the shell layer is occasionally referred to as the “shell resin.” Using a shell resin that is positively chargeable permits the shell resin to double as a positively chargeable charge control agent. As necessary, the shell layer can contain any component other than those mentioned above. To obtain toner suitable for image formation, the thickness of the shell layer is preferably 1 nm or more but 400 nm or less, and more preferably 5 nm or more but 50 nm or less.

### Positively Chargeable Charge Control Agent

The content proportion of the positively chargeable charge control agent relative to the mass of the shell layer is preferably 1 mass % or more but 30 mass % or less, more preferably 5 mass % or more but 20 mass % or less, and particularly preferably 8 mass % or more but 17 mass % or less. With the content proportion of the positively chargeable charge control agent relative to the mass of the shell layer within those ranges, a large amount of positively chargeable charge control agent is present in the surface region of the toner particles and thus the toner can be sufficiently charged in a high-temperature, high-humidity environment.

The ratio WP/WC of the mass WP of the positively chargeable charge control agent to the mass WC of the toner core is preferably 0.0010 or more but 0.0040 or less, and more preferably 0.0015 or more but 0.0035 or less. With the ratio WP/WC in those ranges, a large amount of positively chargeable charge control agent is present in the surface region of the toner particles and thus the toner can be sufficiently charged in a high-temperature, high-humidity environment.

So that, in the treatment process during the manufacture of the toner, the positively chargeable charge control agent can be deposited in the toner particles without being dissolved in alcohol, the positively chargeable charge control agent is preferably insoluble in alcohol.

Examples of positively chargeable charge control agents include, for example, thermoplastic resins containing a quaternary ammonium base, thermosetting nitrogen-containing resins, azine compounds, direct dyes, acid dyes, metal salts of naphthenic acid, metal salts of higher organic carboxylic acids, alkoxylated amines, alkyl amides, and quaternary ammonium salt compounds. A preferred positively chargeable charge control agent is a thermoplastic resin containing a quaternary ammonium base because it is easily attracted to the toner core containing styrene-acrylic resin with an acid number of 7.0 mgKOH/g or more in the shell formation process and because it doubles as the shell resin.

Examples of thermoplastic resins containing a quaternary ammonium base include, for example, vinyl resins containing a quaternary ammonium base, more specific examples including polymers of at least one type of vinyl compound having a quaternary ammonium base, and polymers of at least one type of vinyl compound having a quaternary ammonium base and at least one type of other vinyl compound. This other vinyl compound has no quaternary ammonium base. A vinyl compound has, in its molecule, a vinyl group (CH₂═CH—) or a vinyl group with a hydrogen atom in it replaced (e.g., (CH₂═C(CH₃)—). Through addition polymerization involving cleaving of a carbon double bond (C═C) in the vinyl group, a vinyl compound is polymerized into a polymer (vinyl resin).

Examples of vinyl compounds having a quaternary ammonium base include, for example, vinyl benzyl trialkyl ammonium salts, 2-(acryloyloxy)ethyl trialkyl ammonium salts, and 2-(methacryloyloxy)ethyl trialkyl ammonium salts.

Examples of vinyl benzyl trialkyl ammonium salts includes, for example, vinyl benzyl trimethyl ammonium salts (more specifically, vinyl benzyl trimethyl ammonium chloride and the like), vinyl benzyl triethyl ammonium salts (more specifically, vinyl benzyl triethyl ammonium chloride and the like), vinyl benzyl dimethyl ethyl ammonium salts (more specifically, vinyl benzyl dimethyl ethyl ammonium chloride and the like), vinyl benzyl dimethyl isopropyl ammonium salts (more specifically, vinyl benzyl dimethyl isopropyl ammonium chloride and the like), vinyl benzyl n-butyl dimethyl ammonium salts (more specifically, vinyl benzyl n-butyl dimethyl ammonium chloride and the like), and vinyl benzyl dimethyl pentyl ammonium salts (more specifically, vinyl benzyl dimethyl pentyl ammonium chloride and the like).

Examples of 2-(acryloyloxy)ethyl trialkyl ammonium salts include, for example, 2-(acryloyloxy)ethyl trimethyl ammonium salts (more specifically, 2-(acryloyloxy)ethyl trimethyl ammonium chloride and the like), 2-(acryloyloxy)ethyl dimethyl ethyl ammonium salts (more specifically, 2-(acryloyloxy)ethyl dimethyl ethyl ammonium chloride and the like), 2-(acryloyloxy)ethyl triethyl ammonium salts (more specifically, 2-(acryloyloxy)ethyl triethyl ammonium chloride and the like), and 2-(acryloyloxy)ethyl dimethyl n-pentyl ammonium salts (more specifically, 2-(acryloyloxy)ethyl dimethyl n-pentyl ammonium chloride and the like).

Examples of 2-(methacryloyloxy)ethyl trialkyl ammonium salts include, for example, 2-(methacryloyloxy)ethyl trimethyl ammonium salts (more specifically, 2-(methacryloyloxy)ethyl trimethyl ammonium chloride and the like), 2-(methacryloyloxy)ethyl dimethyl ethyl ammonium salts (more specifically, 2-(methacryloyloxy)ethyl dimethyl ethyl ammonium chloride and the like), and 2-(methacryloyloxy)ethyl dimethyl n-pentyl ammonium salts (more specifically, 2-(methacryloyloxy)ethyl dimethyl n-pentyl ammonium chloride and the like).

A preferred vinyl compound having a quaternary ammonium base is a 2-(methacryloyloxy)ethyl trialkyl ammonium salt, more preferable being a 2-(methacryloyloxy)ethyl trimethyl ammonium salt, still more preferable being 2-(methacryloyloxy)ethyl trimethyl ammonium chloride.

Examples of other vinyl compounds include, for example, those similar to styrene-based monomers and acrylic acid-based monomers that can be used to synthesize the styrene-acrylic resin contained in the binder resin. A preferred other vinyl compound is an alkyl ester of (meth)acrylic acid, more preferable being methyl (meth)acrylate or butyl (meth)acrylate, particularly preferable being methyl methacrylate or butyl acrylate.

A preferred thermoplastic resin containing a quaternary ammonium base is a vinyl resin having a quaternary ammonium base, more preferable being a polymer of a vinyl resin having a quaternary ammonium base and another vinyl compound, still more preferable being a polymer of a 2-(methacryloyloxy)ethyl trialkyl ammonium salt and two or more types of alkyl ester of (meth)acrylic acid, even more preferable being a polymer of a 2-(methacryloyloxy)ethyl trialkyl ammonium salt, methyl (meth)acrylate, and butyl (meth)acrylate, particularly preferable being a polymer of 2-(methacryloyloxy)ethyl trimethyl ammonium chloride, methyl methacrylate, and butyl acrylate.

### Shell Resin

For sufficient charging of the toner in a high-temperature, high-humidity environment, the shell resin preferably is hydrophobic. The shell resin can be, for example, a thermosetting resin, a thermoplastic resin, a mixture of a thermoplastic resin and a thermosetting resin. For improved low-temperature fixing properties of the toner, the shell resin is preferably a thermoplastic resin. Examples of thermoplastic resins include, for example, polyester resins, styrene resins, and styrene acrylic resins. Preferred as the shell resin is styrene acrylic resin because it can satisfactorily coat the toner core containing styrene-acrylic resin.

Styrene-acrylic resin is a polymer of at least one type of styrene-based monomer and at least one type of acrylic rein-based monomer. Examples of styrene-based monomers and acrylic rein-based monomers that can be used to polymerize the shell resin include those similar to the styrene-based monomers and the acrylic rein-based monomers that can be used to polymerize the binder resin.

Preferred as styrene-acrylic resin usable as the shell resin is a polymer of styrene and an alkyl ester of (meth)acrylic acid, more preferable being a polymer of styrene and butyl (meth)acrylic acid, still more preferable being a polymer of styrene and butyl acrylate.

In a case where styrene-acrylic resin is used as the shell resin, the content proportion of styrene-acrylic resin relative to the mass of the shell resin is preferably 70 mass % or more but 99 mass % or less, more preferably 80 mass % or more but 95 mass % or less, and particularly preferably 83 mass % or more but 92 mass % or less.

The ratio WP/WS of the mass WP of the positively chargeable charge control agent relative to the mass WS of styrene-acrylic resin is preferably 0.05 or more but 0.50 or less, and more preferably 0.10 or more but 0.20 or less.

The ratio WS/WC of the mass WS of styrene-acrylic resin relative to the mass WC of the toner core is preferably 0.01 or more but 0.05 or less.

The glass transition point of styrene-acrylic resin usable as the shell resin is preferably 60° C. or more but 100° C. or less, and more preferably 65° C. or more but 75° C. or less.

### Other Components

Examples of other components that the shell resin can contain include, for example, a pH adjustment agent, an emulsifier, and any known additive other than those.

### External Additive

In a case where the toner particles contain an external additive, the external additive can be, for example, inorganic particles, and of which examples more specifically include particles of silica and particles of metal oxides (specifically, alumina, titanium oxide, magnesium oxide, zinc oxide, strontium titanate, barium titanate, and the like). The surface of the external additive can be subjected to one or both of positive charging treatment and hydrophobizing treatment. The content proportion of the external additive relative to 100.0 mass parts of the toner base particles is preferably 0.5 mass parts or more but 10.0 mass parts or less. The number average primary particle diameter of the external additive is preferably 5 nm or more but 80 nm or less.

### Method of Manufacturing Toner

A method of manufacturing the toner of the embodiment will now be described. The toner of the embodiment can be manufactured through, for example, an untreated toner particle formation process and a treatment process. In a case where the toner is capsule toner, the untreated toner particle formation process includes, for example, a toner core formation process and a shell layer formation process. In a case where the toner is non-capsule toner, the shell layer formation process is omitted and the toner core formation process corresponds to the untreated toner particle formation process. These processes will be described one by one below.

### Untreated Toner Particle Formation Process

In the untreated toner particle formation process, untreated toner particles that contain a binder resin, a positively chargeable charge control agent, and any other component added as necessary are obtained.

### Toner Core Formation Process

In the toner core formation process, a toner core is formed by, for example, a flocculation method or a pulverization method.

The flocculation method involves, for example, a flocculation process and a merging process. In the flocculation process, fine particles containing components for forming a toner core are flocculated in a water-based medium to form flocculate particles. In the merging process, the components contained in the flocculate particles are merged in the water-based medium to form a toner core.

Next, the pulverization method will be described. The pulverization method allows comparatively easy formation of a toner core and also helps reduce the manufacturing cost. In a case where a toner core is formed by the pulverization method, the toner core formation process involves, for example, a mixing process, a kneading process, and a pulverizing process. The toner core formation process can further involve, after the pulverizing process, at least one of a fine pulverizing process and a classifying process.

In the mixing process, a binder resin and any internal additive added as necessary are mixed to obtain a mixture. In the kneading process, the mixture is melted and kneaded to obtain a kneaded substance. In the pulverizing process, the kneaded substance is cooled down to, for example, room temperature (25° C.) and is then pulverized to obtain a pulverized substance. If a smaller particle diameter is desired in the pulverized substance obtained in the pulverizing process, a fine pulverizing process can be performed to further pulverize the pulverized substance. To obtain a pulverized substance with a uniform particle diameter, a classifying process can be performed to classify the pulverized substance. Through these processes, a toner core is obtained in the form of a pulverized substance.

### Shell Layer Formation Process

In the shell layer formation process, a shell layer is formed on the surface of the toner core. The shell layer can be formed, for example, by an in-situ polymerization method, a submerged curing film method, or a core selvation method. Some suitable specific examples will be described below.

First, a material for forming the shell layer (in the following description, occasionally referred to as the “shell material”) and the toner core obtained in the toner core formation process are put in a water-based medium. The shell material can be, for example, a positively chargeable charge control agent with any component added as necessary (e.g., at least one of a shell resin and another component). The water-based medium containing the shell material and the toner core is heated to promote the polymerization reaction of the shell material so that a shell layer is formed on the surface of the toner core. In this way, untreated toner particles are obtained that are composed of a toner core and a shell layer that coats the surface of the toner core.

In a case where the shell material is resin particles (e.g., hydrophobic resin particles and positively chargeable resin particles doubling as a positively chargeable charge control agent), heating the water-based medium containing the resin particles and the toner core results in attaching the resin particles to the surface of the toner core and meanwhile letting the resin particles turn into a film so that a shell layer is formed on the surface of the toner core.

As already mentioned, the toner core contains, as the most abundant resin contained in the binder resin, styrene-acrylic resin with an acid number of 7.0 mgKOH/g or more. In the water-based medium, the carboxy group in the styrene-acrylic resin turns into an anionic group (e.g., —COO— group) and attracts a large amount of positively chargeable charge control agent. Moreover, the toner core containing the binder resin with a high acid number attracts a large amount of positively chargeable charge control agent as the shell material. Furthermore, owing to the formation of the shell layer containing the positively chargeable charge control agent, the positively chargeable charge control agent can be arranged in a concentrated manner near the surface of the untreated toner particles. These factors combine to make it possible to manufacture toner that can be sufficiently charged in a high-temperature, high-humidity environment.

Preferably, the temperature to which the water-based medium containing the shell material and the toner core is heated (i.e., shell formation temperature) is higher than the glass transition point of the shell material. The shell formation temperature is preferably 50° C. or more but 90° C. or less, and more preferably 60° C. or more but 80° C. or less. The time for which the water-based medium containing the shell material and the toner core is heated (i.e., shell formation time) is preferably 0.1 hours or more but 3.0 hours or less, and more preferably 0.3 hours or more but 1.0 hour or less.

### Treatment Process

In the treatment process, the untreated toner particles obtained in the untreated toner particle formation process are treated with alcohol to obtain toner particles. The method of the treatment can be, for example, adding alcohol to the untreated toner particles and heating them while stirring. If in the shell layer formation process the untreated toner particles are obtained in the form of a dispersion liquid of the untreated toner particles dispersed in the water-based medium, alcohol can be added to the dispersion liquid of the untreated toner particles dispersed in the water-based medium.

For satisfactory reduction of the acid number in the exposed region on the surface of the toner core, examples of the alcohol usable in the treatment process include, for example, alcohols with a number of carbon atoms of one to three, and more specifically methanol, ethanol, and propanol (e.g., 1-propanol and 2-propanol).

For satisfactory reduction of the acid number in the exposed region on the surface of the toner core, the amount of alcohol added in the treatment process per gram of untreated toner particles is preferably 0.05 mL or more but 0.10 mL or less, and more preferably 0.06 mL or more but 0.07 mL or less. To the same end, the heating temperature in the treatment process is preferably 40° C. or more but 60° C. or less, and more preferably 45° C. or more but 50° C. or less. To the same end, the stirring time in the treatment process is preferably 0.1 hours or more but 5.0 hours or less, and more preferably 1.0 hours or more but 3.0 hours or less.

For sufficient charging of the toner in a high-temperature, high-humidity environment, the binder resin contained in the toner core is given an increased acid number (specifically, the styrene-acrylic resin is given an acid number of 7.0 mgKOH/g or more) so that, in the shell layer formation process, a shell layer containing a large amount of positively chargeable charge control agent is formed. This permits the toner to be sufficiently charged in a high-temperature, high-humidity environment. However, an increased acid number of the binder resin tends to result in quick attenuation of the charge on the toner particles in a high-temperature, high-humidity environment. To cope with that, in the treatment process, the acid number in the surface region of the untreated toner particles (more specifically, the acid number in the exposed region on the surface of the toner core contained in the untreated toner particles) is reduced with alcohol. This makes the charge on the toner particles less prone to attenuate. Performing the shell layer formation process and the treatment process described above helps achieve sufficient charging properties of the toner while preventing excessive charge attenuation in a high-temperature, high-humidity environment.

As described above with reference to FIGS. 2A and 2B, the toner core has, in the exposed region, an alkoxycarbonyl group formed through the esterification reaction of the carboxy group in styrene-acrylic resin with alcohol. The esterification reaction turns the carboxy group in the exposed region on the surface of the toner particles into an alkoxycarbonyl group, and thus the acid number B on the surface of the toner particles after the treatment process is lower than the acid number A on the surface of the untreated toner particles before the treatment process. To adjust the charge attenuation constant of the toner particles to a value within a desired range, preferably, the acid number A on the surface of the untreated toner particles and the acid number B on the surface of the toner particles obtained in the treatment process fulfill Expression (1) below

$$B / A \leq 0.7 \qquad ( 1 )$$

In a case where the toner particles contain an external additive, the “acid number A on the surface of the untreated toner particles” and the “acid number B on the surface of the toner particles obtained in the treatment process” respectively mean the acid number of the untreated toner base particles (the untreated toner base particles before mixing with the external additive) and the acid number of the treated toner base particles (the treated toner base particles after mixing with the external additive). The treatment process can further involve, as necessary, at least one of a cooling process, a washing process, and a drying process.

### External Additive Mixing Process

The toner particles obtained in the treatment process (corresponding to, in a case where an external additive mixing process is performed, the toner base particles) can be, as necessary, subjected to an external additive mixing process. In the external additive mixing process, an external additive is attached to the surface of the toner base particles to obtain toner particles. The method of attaching the external additive to the surface of the toner base particles can be, for example, stirring the toner base particles and the external additive in a mixer or the like.

### EXAMPLES

Practical examples of the present disclosure will be described below. It should however be understood that those practical examples are in no way meant to limit the scope of the present disclosure. First, the methods for the measurement of property values will be described.

### Number Average Primary Particle Diameter

The number average primary particle diameter of the resin particles in a suspension was measured under a transmission electron microscope.

### Glass Transition Point

The glass transition point (Tg) of resin or resin particles was measured using a differential scanning calorimeter (“DSC-6220” manufactured by Seiko Instruments Inc.) in conformity with JIS (Japanese Industrial Standards) K7121-201.

### Binder Resin

The resins used as the binder resin are listed in Table 1 below. The binder resins (ST-1) to (ST-4) listed in Table 1 are manufactured by Fujikura Kasei Co., Ltd. The binder resins (PE-A) to (PE-B) listed in Table 1 are manufactured by Kao Corporation.

Table 1 is as follows

TABLE 1

| Binder | | Acid Number | Tg |
|---|---|---|---|
| Resin | Type | [mgKOH/g] | [° C.] |
| ST-1 | Low-Viscosity Styrene Acrylic Resin | 7.1 | 48 |
| ST-2 | Low-Viscosity Styrene Acrylic Resin | 15.0 | 47 |
| ST-3 | High-Viscosity Styrene Acrylic Resin | 8.8 | 58 |
| ST-4 | Low-Viscosity Styrene Acrylic Resin | 3.0 | 48 |
| PE-A | High-Viscosity Polyester Resin | 0.2 | 58 |
| PE-B | Low-Viscosity Polyester Resin | 0.2 | 48 |

### Suspension for Shell Formation

For use in the formation of the shell layer, suspensions SA and SB were prepared in the following manners.

### Suspension SA of Hydrophobic Resin Particles

A three-neck flask provided with a thermometer and a stirring blade was loaded with 875 mL of ion-exchanged water and 75 mL of anionic surfactant (“LATEMUL (registered trademark) WX” manufactured by Kao Corporation; component: sodium polyoxyethylene alkyl ether sulfate; solid content concentration: 26 mass %). Using a water bath, the contents of the flak were heated to 80° C. Into the flask, two kinds of liquid (a first and a second liquid) were dropped, each over a duration of 5 hours. The first liquid was a mixture liquid of 18 mL of styrene and 2 mL of butyl acrylate. The second liquid was a solution of 0.5 g of potassium persultfate dissolved in 30 mL of ion-exchanged water. Subsequently, while the temperature in the flask was kept at 80° C., the contents of the flask were stirred for two hour to be polymerized. In this way, suspension SA was obtained. Suspension SA contained hydrophobic resin particles of a polymer of styrene and butyl acrylate. The number average primary particle diameter and the glass transition point of the hydrophobic resin particles in suspension SA were 32 nm and 71° C. respectively.

### Suspension SB of Positively Chargeable Resin Particles

A three-neck flask provided with a thermometer, a cooling tube, a nitrogen introduction tube, and a stirring blade was loaded with 90 g of isobutanol, 100 g of methyl methacrylate, 35 g of butyl acrylate, 30 g of 2-(methacryloyloxy)ethyl trimethyl ammonium chloride (manufactured by Alfa Aesar), and 6 g of 2,2′-azobis [2-methyl-N-(2-hydroxyethyl)propionamide] (“VA-086” manufactured by Wako Pure Chemical Corporation). The contents of the flask were reacted for three hours at 80° C. in a nitrogen atmosphere. The flask was then additionally loaded with 3 g of VA-086 and the contents were further reacted for another three hours at 80° C. in a nitrogen atmosphere to obtain a polymer solution. This polymer solution was dried at 150° C. under reduced pressure and was pulverized to obtain positively chargeable resin. Using a mixer (“HIVIS MIX (registered trademark), Model 2P-1” manufactured by PRIMIX Corporation), 200 g of the positively chargeable resin and 184 mL of ethyl acetate (special grade, manufactured by Wako Pure Chemical Corporation) were stirred for one hour at a speed of 20 rpm. This yielded a homogeneous high-viscosity solution. To this solution, a third liquid was added. The third liquid was a solution in 562 g of ion-exchanged water of 18 mL of 1N chloric acid, 20 g of anionic surfactant (“EMAL (registered trademark) 0” manufactured by Kao Corporation; component: sodium lauryl sulfate), and 16 g of ethyl acetate. In this way, suspension SB was obtained. Suspension SB contained positively chargeable resin particles of positively chargeable resin. The number average primary particle diameter of the positively chargeable resin particles in suspension SB was 35 nm.

### Toner

The toners used in practical and comparative examples were prepared in the following manners. The details of the toners are listed in Table 2 below.

Table 2 is as follows:

TABLE 2

| | Toner Core | | | | | | Shell | |
|---|---|---|---|---|---|---|---|---|
| | | | | | Release | | Resin | |
| | Binder Resin | | | | Agent | Colorant | SB | |
| | | Q'ty | | Q'ty | Q'ty | Q'ty | Q'ty | |
| Toner | Type | [Parts] | Type | [Parts] | [Parts] | [Parts] | [ml] | Treatment |
| T-A1 | ST-1 | 63 | PE-A | 24 | 5 | 8 | 2.5 | Yes |
| T-A2 | ST-1 | 63 | PE-A | 24 | 5 | 8 | 5.0 | Yes |
| T-A3 | ST-2 | 63 | PE-A | 24 | 5 | 8 | 2.5 | Yes |
| T-A4 | ST-2 | 63 | PE-A | 24 | 5 | 8 | 5.0 | Yes |
| T-A5 | ST-3 | 65 | PE-B | 25 | 5 | 5 | 2.5 | Yes |
| T-A6 | ST-3 | 65 | PE-B | 25 | 5 | 5 | 5.0 | Yes |
| T-B1 | ST-4 | 63 | PE-A | 24 | 5 | 8 | 2.5 | Yes |
| T-B2 | PE-A | 63 | ST-1 | 24 | 5 | 8 | 2.5 | Yes |
| T-B3 | ST-1 | 63 | PE-A | 24 | 5 | 8 | 2.5 | No |
| T-B4 | ST-2 | 63 | PE-A | 24 | 5 | 8 | 2.5 | No |
| T-B5 | ST-1 | 63 | PE-A | 24 | 5 | 8 | — | Yes |

In Table 2, “parts” are mass parts. Used as the “release agent” in Table 2 was ester wax (“NISSAN ELECTOL (registered trademark) WEP-3” manufactured by NOF CORPORATION). Used as the “colorant” in Table 2 was carbon black (“REGAL (registered trademark) 330” manufactured by Cabot Corporation). In Table 2 “SB” stands for suspension SB of positively chargeable resin particles described above, and “-” indicates that no suspension SB was mixed. The positively chargeable resin particles in suspension SB correspond to a charge control agent.

### Toner (T-A1)

### Toner Core Formation Process

63 mass parts of binder resin (ST-1), 24 mass parts of binder resin (PE-A), 5 mass parts of release agent, and 8 mass parts of colorant were mixed at a rotation speed of 2400 rpm using an FM mixer. Using a biaxial extruder, the mixture was melted and kneaded under the conditions of a material feed rate of 5 kg/hour, a spindle rotation rate of 160 rpm, and a set temperature range of 80° C. or more but 130° C. or less. The kneaded substance was cooled. The cooled kneaded substance was coarse-pulverized using a Rotoplex Mill (registered trademark). The coarse-pulverized substance was fine-pulverized using a jet mill (“Ultrasonic Jet Mill, Type I” manufactured by Nippon Pneumatic Mfg. Co.). The fine-pulverized substance was classified using an elbow jet (“EJ-LABO” manufactured by Nittetsu Mining Co. Ltd.).

### Shell Layer Formation Process

A three-neck flask provided with a thermometer and a stirring blade was loaded with 100 mL of ion-exchanged water. Using a water bath, the temperature of the contents of the flask was kept at 30° C. Into the flask, diluted chloric acid was added to adjust the pH of the contents of the flaks to four. The flask was further loaded with, as shell materials, 250.0 mL of suspension SA and 2.5 mL of suspension SB. Into the flask, 300 g of the toner core was added and the contents of the flask were stirred for one hour at a speed of 200 rpm. Next, into the flask, 300 mL of ion-exchanged water was added. While the contents of the flask were stirred at a speed of 100 rpm, the temperature in the flak was raised to 70° C. at a heating rate of 1° C./min. After the heating, the contents of the flask were stirred for 30 minutes at 70° C. Next, the contents in the flask were cooled down to 50° C. to obtain a dispersion liquid containing untreated toner base particles. The untreated toner base particles had a toner core and a shell layer coating the toner core. The shell layer was composed of hydrophobic resin originating from the hydrophobic resin particles in suspension SA and positively chargeable resin originating from the positively chargeable resin particles in suspension SB.

### Treatment Process

The dispersion liquid containing the untreated toner base particles was mixed with 20 mL of 1-propanol and was stirred for two hours at 50° C. In this way, a dispersion liquid containing treated toner base particles was obtained.

### Cooling Process

The dispersion liquid containing treated toner base particles in the flask was mixed with sodium hydroxide to adjust the pH of the contents of the flask to seven, and was cooled down to room temperature (25° C.).

### Washing Process

Using a Buchner funnel, from the dispersion liquid containing the toner base particles, a wet cake of toner base particles was filtered out. The wet cake of toner base particles was dispersed in ion-exchanged water to wash the toner base particles (washing operation). This washing operation was repeated five times.

### Drying Process

The washed wet cake of toner base particles was dispersed in an aqueous solution of ethanol with a concentration of 50 mass % to obtain slurry. Using a continuous surface improvement device (“Coatmizer (registered trademark)” manufactured by Freund Corporation), the toner base particles in the slurry were dried under the conditions of a hot air temperature of 45° C. and a blower air rate of 2 m³/min. In this way, dried toner base particles were obtained. Under a scanning electron microscope, the surface of the dried toner base particles was inspected: while the suspension particles appeared to be fairly granular, they were not observed to have separated.

### External Additive Mixing Process

100 mass parts of the dried toner base particles, 2.0 mass parts of silica (“RA-200H” manufactured by Nippon Aerosil Co., Ltd.), and 1.5 mass parts of titanium oxide (“EC0100” manufactured by Titan Kogyo, Ltd.) were mixed for five minutes using an FM mixer (manufactured by Nippon Coke & Engineering. Co., Ltd., with a volume of 10 L). Thereby the external additives (silica and titanium oxide) were attached to the surface of the toner base particles. The toner base particles having external additives attached to them are passed through a sieve with a No. 200 mesh (with 75 μm openings). In this way, toner (T-A1) containing toner particles was obtained.

### Toners (T-A2) to (T-A6) and (T-B1) to (T-B5)

Through processes similar to those for toner (T-A1), toners (T-A2) to (T-A6) and (T-B1) to (T-B5) were prepared except that the types and quantities of binder resins used in the toner core formation process, the quantity of suspension SB of positively chargeable resin particles used in the shell layer formation process, and whether to perform the treatment process were varied as listed in Table 2. For those toners for which the treatment process was not performed, the cooling process was performed by using, in place of the dispersion liquid containing treated toner base particles, the dispersion liquid containing untreated toner base particles obtained in the shell layer formation process.0

### Measurement

With each toner, the ratio B/A, the charge amount, and the charge attenuation constant were measured in the following manners. The measurement results are listed in Table 3 below.

### Ratio B/A

With each measurement target (untreated toner base particles before the external additive mixing process and treated toner base particles after the external additive mixing process), the acid number was measured in the following manner. Used as the measurement target of the measurement of acid number A were untreated toner base particles obtained, without the treatment process performed after the shell layer formation process, through the cooling process, the washing process, and the drying process (i.e., untreated toner base particles before the external additive mixing process). Used as the measurement target of the measurement of acid number B were toner base particles obtained, with the treatment process performed after the shell layer formation process, through the cooling process, the washing process, and the drying process (i.e., treated toner base particles after the external additive mixing process). From acid numbers A and B so measured, the ratio B/A was calculated according to the expression “B/A=(Acid Number B)/(Acid Number A).” A lower ratio B/A indicates further progress of the esterification reaction of the carboxy group in the styrene-acrylic resin contained on the binder resin with the alcohol used in the treatment process and hence further formation of the alkoxycarbonyl group and further reduction of the carboxy group in the exposed region of the toner core.

### Acid Number Measurement

First, for use in titration, a solution “a” of potassium hydroxide in ethanol was prepared. Specifically, 7 g of potassium hydroxide prescribed in JIS (Japanese Industrial Standards) K 8574 was dissolved in 5 mL of water to obtain an aqueous solution of potassium hydroxide. This aqueous solution of potassium hydroxide was mixed with ethanol (purity: 95% volume) prescribed in JIS (Japanese Industrial Standards) K 8102 so that the total volume was 1 L. Thus, a solution “a” of potassium hydroxide in ethanol with a concentration of 0.1 mol/L was prepared.

Next, 0.5 g of anionic surfactant (“EMAL (registered trademark) 0” manufactured by Kao Corporation; component: sodium lauryl sulfate) was dissolved in 100 g of ion-exchanged water to obtain an aqueous solution “b” of surfactant. Using an ultrasonic water bath, 0.2 g of the measurement target was dispersed in the aqueous solution “b” of surfactant to obtain a dispersion liquid “c” of the measurement target. While the pH of the dispersion liquid “c” was measured using a pH meter (“WQ-300” manufactured by Horiba Ltd.), the solution “a” of potassium hydroxide was kept dropped into the dispersion liquid “c.” From the dropped volume observed when the pH of the dispersion liquid “c” was 7.00, the acid number (in mgKOH/g) of the measurement target was calculated.

### Charge Amount

10.0 g of non-coat ferrite carrier (“EF-35” manufactured by Powdertech) and 0.8 g of the toner base particles obtained in the drying process (i.e., toner base particles before the external additive mixing process) are sealed in a resin container with a volume of 20 mL. The container was left to stand still for 12 hours in the predetermined HH environment. Next, in the predetermined HH environment, using a Rocking Mixer (registered trademark), the contents of the container were stirred for 30 minutes under the condition of a stirring speed of 30 rpm. After the stirring, a sample was collected from the container and the charge amount (in μC/g) of the toner base particles contained in the sample was measured using a Q/m meter (“Model 210HS” manufactured by Trek Inc.).

### Charge Attenuation Constant

The charge attenuation constant of toner base particles was measured using an electrostatic diffusion rate measurement device (“NS-D101” manufactured by Nano Seeds Corporation) in conformity with JIS (Japanese Industrial Standards) C61340-2-1-2006. Specifically, a measurement cell was loaded with the toner base particles obtained in the drying process (i.e., toner base particles before the external additive mixing process). The measurement cell was a metal cell having a depression formed in it with an inner diameter of 10 mm and a depth of 1 mm. Using a slide glass, the toner base particles were pushed from above into the depression in the cell so as to fill it. Across the surface of the cell, the slide glass was moved to and fro to remove the toner base particles left outside the depression. The measurement cell was filled with 0.05 g of toner base particles. The measurement cell filled with the toner base particles was left to stand still for 12 hours in the predetermined HH environment. Subsequently, The measurement cell, grounded, is placed in the electrostatic diffusion rate measurement device and the toner base particles were fed with ions by corona discharge to be electrostatically charged. The probe gap was 1 mm and the discharge time was 0.5 seconds. Starting at 0.7 seconds after the end of corona discharge, the surface potential on the toner base particles was measured continuously under the condition of a sampling frequency of 1 Hz. From the measured surface potential on the toner base particles, the charge attenuation constant (charge attenuation speed) a was calculated according to the expression “V=V0 exp(α√t).” In the expression, V is the surface potential (in V) on the toner base particles, V0 is the initial surface potential on the toner base particles (in V), and t is the attenuation time (in seconds).

### Evaluation

The images formed using the different tones were evaluated in the following manners in terms of thin lines and tonner scattering. The evaluation results are shown in Table 3 below.

### Thin Lines

Two-component developer containing toner as an evaluation target and sheets of A4 size were set in a test machine (“TASKalfa9003i” manufactured by Kyocera Document Solutions Inc.) and were left to stand still for 12 hours in the predetermined HH environment. Then, in the predetermined HH environment, using the test machine, an evaluation image was formed on a sheet. The evaluation image was an image of five thin lines. These thin lines were arranged parallel to the longitudinal direction (length direction) of the sheet, each with a font size of 0.25 points and a length equal to the length of the sheet in the longitudinal direction. The left and right margins on the sheet had a width of 30 mm each and the intervals between the thin lines were about 20 mm. The thin lines were evaluated according to the following criteria.

### Criteria for Thin Lines

A (Good): No break of 0.5 mm or more was observed in the thin lines.

B (Poor): A break of 0.5 mm or more was observed in the thin lines.

### Toner Scattering

The evaluation image formed for the thin line evaluation described above was visually inspected to check for soil near the thin lines that is ascribable to toner scattering. If soil was observed, the image density was measured at five points in the soiled part and the average value was taken as the soil image density IX. The image density was measured at five points also in a blank part of the evaluation image and the average value was taken as the blank image density IY. Then the image density difference was calculated according to the expression “(Image Density Difference)=(Soil Image Density)−(Blank Image Density).” Toner scattering was evaluated according to the following criteria.

### Criteria for Toner Scattering

A (Good): No soil ascribable to toner scattering was observed, or soil ascribable to toner scattering was observed with an image density difference less than 0.01.

B (Poor): Soil ascribable to toner scattering was observed with an image density difference of 0.01 or more.

Table 3 is as follows, where “EX1” stands for Example 1, “EX2” stands for Example 2, “EX3” stands for Example 3, “EX4” stands for Example 4, “EX5 stands for Example 5, “EX6” stands for Example 6, “CEX1” stands for Comparative Example 1, “CEX2” stands for Comparative Example 2, “CEX3” stands for Comparative Example 3, “CEX4” stands for Comparative Example 4, and “CEX5” stands for Comparative Example 5:

TABLE 3

| | | | Charge | Charge | Evaluation | |
|---|---|---|---|---|---|---|
| | | | Amount | Attenuation | Thin | Toner |
| | Toner | B/A | [μC/g] | Constant | Line | Scatter |
| EX1 | T-A1 | 0.58 | +11.2 | −0.0177 | A | A |
| EX2 | T-A2 | 0.62 | +18.8 | −0.0179 | A | A |
| EX3 | T-A3 | 0.60 | +16.4 | −0.0181 | A | A |
| EX4 | T-A4 | 0.66 | +19.1 | −0.0193 | A | A |
| EX5 | T-A5 | 0.60 | +11.3 | −0.0179 | A | A |
| EX6 | T-A6 | 0.62 | +18.4 | −0.0185 | A | A |
| CEX1 | T-B1 | 0.65 | +6.5 | −0.0099 | Image not formed. | |
| CEX2 | T-B2 | 0.50 | +1.1 | −0.0007 | Image not formed. | |
| CEX3 | T-B3 | 1.00 | +9.8 | −0.0433 | B | — |
| CEX4 | T-B4 | 1.00 | +15.9 | −0.0489 | B | — |

| | | | | | |
|---|---|---|---|---|---|
| CEX5 | T-B5 | 0.58 | −0.2 | −0.0005 | Image not formed. |

In Table 3, “Image not formed” indicates that the toner was not charged sufficiently to print the evaluation image on the sheet. A dash “-” indicates that the fine lines had a poor evaluation and thus that no evaluation of toner scattering was performed.

In toners (T-B1) to (T-B2), the most abundant resin (specifically, binder resins (ST-4) and (PE-A)) was not styrene-acrylic resin with an acid number of 7.0 mgKOH/g or more. With toners (T-B1) to (T-B2), the evaluation image cannot be printed on the sheet.

In toners (T-B3) to (T-B4), the charge attenuation constant of the toner particles was not −0.0200 or more in the predetermined HH environment. With toners (T-B3) to (T-B4), the evaluation of thin lines was poor.

In toners (T-B5), the toner particles did not contain a positively chargeable charge control agent (more specifically, positively chargeable resin originating from positively chargeable resin particles in suspension SB). With toners (T-B5), the evaluation image cannot be printed on the sheet.

On the other hand, with toners (T-A1) to (T-A6), the toner particles contained a binder resin and a positively chargeable charge control agent (more specifically, positively chargeable resin originating from the positively chargeable resin particles in suspension SB). The most abundant resin (more specifically, one of binder resins (ST-1) to (ST-3)) in the binder resin was styrene-acrylic resin with an acid number of 7.0 mgKOH/g or more. The charge attenuation constant of the toner particles was −0.0200 or more in the predetermined HH environment. With any of toners (T-A1) to (T-A6), the evaluation of both thin lines and toner scattering was good.

The foregoing leads to the conclusion: toners, including toners (T-A1) to (T-A6), according to the present disclosure and toners manufactured by methods according to the present disclosure can form high-quality images with no breaks in thin lines and no toner scattering in a high-temperature, high-humidity environment.

Toners according to the present disclosure and toners manufactured by methods according to the present disclosure can form high-quality images in a high-temperature, high-humidity environment.

Toners according to the present disclosure and toners manufactured by methods according to the present disclosure can be used to form images on, for example, copiers, printers, and multifunction peripherals.

What is claimed is:

1. Toner containing toner particles, wherein
the toner particles contain a binder resin and a positively chargeable charge control agent,
a most abundant resin in the binder resin in terms of mass is styrene-acrylic resin with an acid number of 7.0 mgKOH/g or more, and
a charge attenuation constant of the toner particles is −0.0200 or more in an environment of a temperature of 32.5° C. and a relative humidity of 80%.

2. The toner according to claim 1, wherein a charge amount of the toner particles is +10.0 μC/g or more in an environment of a temperature of 32.5° C. and a relative humidity of 80%.

3. The toner according to claim 1, wherein
the positively chargeable charge control agent is a thermoplastic resin having an quaternary ammonium base.

4. The toner according to claim 1, wherein
the toner particles have a toner core and a shell layer coating the toner core,
the toner core contains the binder resin, and
the shell layer contains the positively chargeable charge control agent.

5. The toner according to claim 4, wherein
the toner core does not contain the positively chargeable charge control agent.

6. The toner according to claim 4, wherein
a surface of the toner core includes a coated region coated by the shell layer and an exposed region not coated by the shell layer, and
an acid number in the exposed region on the surface of the toner core is lower than an acid number in an inner region of the toner core.

7. The toner according to claim 4, wherein
a surface of the toner core includes a coated region coated by the shell layer and an exposed region not coated by the shell layer, and
the toner core has an alkoxycarbonyl group in the exposed region.

8. A method of manufacturing the toner according to claim 1, comprising:
a treatment process of treating untreated toner particles with alcohol to obtain the toner particles.

9. The method according to claim 8, wherein
an acid number A on a surface of the untreated toner particles and an acid number B on a surface of the toner particles obtained in the treatment process fulfill expression (1) below:
$$B / A \leq 0.7 . \qquad ( 1 )$$

10. The method according to claim 8, wherein
the toner particles have a toner core and a shell layer coating the toner core,
the toner core contains the binder resin,
the shell layer contains the positively chargeable charge control agent,
a surface of the toner core includes a coated region coated by the shell layer and an exposed region not coated by the shell layer, and
the toner core has, in the exposed region, an alkoxycarbonyl group formed through an esterification reaction of a carboxy group in the styrene-acrylic resin with the alcohol.
